(19) United States
(12) Patent Application Publication
(10) Pub. No.: US 2010/0152985 A1
(43) Pub. Date: Jun. 17, 2010

(54) METHOD AND DEVICE FOR CONTROLLING THE DEGREE OF ENGAGEMENT OF AN AUTOMATIC OR AUTOMATED MOTOR VEHICLE CLUTCH

(75) Inventors: Rainer Petzold, Friedrichshafen (DE); Peter Herter, Ravensburg (DE); Franz Bitzer, Friedrichshafen (DE); Joachim Staudinger, Ravensburg (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/600,717

(22) PCT Filed: Apr. 28, 2008
(86) PCT No.: PCT/EP08/55131

§ 371 Date: Nov. 18, 2009

(30) Foreign Application Priority Data
May 26, 2007 (DE) 10 2007 024 794.1

(51) Int. Cl. G06F 17/00; F16D 25/04

(52) U.S. Cl. 701/68; 192/54.3

(57) ABSTRACT

A method and a device for controlling an automatic or automated clutch (4) of a vehicle, by a pressure fluid drive actuator (6) whereby the waypoint of a part (piston rod 12), connected with the drive actuator (6), is captured via a displacement sensor (28) and entered, as a control parameter, into a clutch control interacting with the vehicle control system (26). Provision is made for a diversified redundancy by use of a pressure sensor (30) measuring the fluid pressure in the drive actuator (6). The pressure sensor (30) monitors and stores the pressure in the drive actuator (6) and pressure changes, when engaging or disengaging the clutch, as a curve in the vehicle control system (26). Hereby, the level of engagement of the clutch is represented by the waypoint of drive actuator (6) by the pressure in the drive actuator (6) so that, if there is a malfunction in the displacement sensor (28), an emergency drive function is maintained.

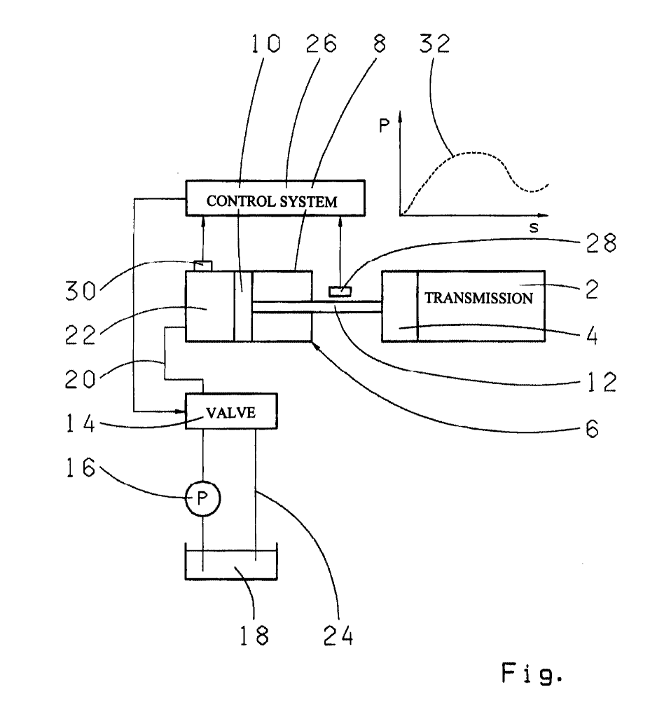

This application is a National Stage completion of PCT/EP2008/055131 filed Apr. 28, 2008, which claims priority from German patent application serial no. 10 2007 024 794.1 filed May 26, 2007.

### FIELD OF THE INVENTION

This invention concerns a method and a device for controlling of an automatic or automated motor vehicle clutch.

### BACKGROUND OF THE INVENTION

Automatic or automated clutches in motor vehicles are friction clutches, which are being engaged or disengaged by means of a pneumatic or a hydraulic actuator, while the movement in the opposite direction of a position is being achieved by a clutch spring. For instance, the actuator is being activated by a vehicle's control unit, through an insertion of a clutch controller, where the vehicle's control unit is receiving a signal, as an input parameter, which is correlating with the clutch's pedal movement (automated clutch), or, a signal being predetermined by a clutch control program. A displacement sensor, which is gathering the travel of a part which is being mechanically linked to the actuator, is providing a signal, serving as reference, to the vehicle control system. The travel signal is representing the actual level of the clutch's engagement, which is being analyzed by the vehicle control unit. Through the clutch's engagement and further signals, for instance, the rotation speed of the engine and/or rotation speed of the transmission's input shaft, the clutch's transfer of torque can be determined through the related functions.

Already known from DE 695 31 427 T2 is a clutch control system, where a sensor is capturing the position of the clutch's release fork, or the engagement, respectively, of a friction clutch, and being analyzed in a control unit, to determining the misuse of the clutch. This publication is not mentioning a measure or device for a situation, where a probe, or sensor, respectively, might be failing, resulting in a failure of the corresponding clutch control.

Because of functional safety, high demands are being placed on the displacement signal. Depending on the requirements of the functional safety, and/or the availability of the vehicle's functions, redundancies might occur. In general, redundancies are being accomplished by providing several, similar systems, therefore, in this case several displacement sensors being positioned in parallel, so that the functionality of a sensor, when failing, is being performed by another displacement sensor. This philosophy of redundancy has limitations, for instance, if a single part, which is following several redundant parts, is failing, and the redundancy of the duplicated parts is no longer being applicable.

### SUMMARY OF THE INVENTION

With that in mind, it is this invention's task to creating a method and a device for controlling an automatic or automated vehicle's clutch, being activated by a pressure fluid actuator, having a displacement sensor which is capturing the degree of engagement, and providing a secure redundancy of the displacement sensor, in which the above mentioned disadvantages of the so called simple redundancy are not occurring.

The invention is being based on the knowledge that a redundancy needs to be working independently from the function which needs to be secured, avoiding hereby the above mentioned disadvantages.

Hereby, the invention is based on a method and a device, for controlling an automatic or automated clutch of a vehicle, by means of a pressure fluid operated actuator, in which the movement over distance of a part (actuator) is being captured by a displacement sensor, being linked with the actuator, and being entered as a control parameter into a clutch control, interacting with the vehicle's control unit.

To solve the task, it is being intended that a change in the actuator's pressure, over the distance, is going to be represented in a graph, and that the pressure in the actuator is being captured by the pressure sensor and being analyzed, as an additional control parameter, for the clutch control unit.

When being at a certain waypoint position of the clutch's actuator, and that thereby the clutch's engagement, under regular operation, is corresponding with a certain fluid pressure in the actuator, a so called diversity redundancy is herewith being created, so that the engagement, in addition, is also being captured through the actuator's fluid pressure. In case of a failure of the displacement sensor, the diversity redundancy is enabling at least an emergency functionality of the system.

In accordance with an embodiment of this invention, the actual pattern of the actuator's pressure, in the engagement movement and disengagement movement of the clutch, is being stored and is being compared to actuators waypoint, and that the named pressure-waypoint curve is being updated with the actual pressure values. The actualization of the pressure-waypoint curve is being provided during each activation of the clutch, or in predetermined intervals.

The method of this invention is providing, for instance, the option that the actual disengagement force curve is automatically being learned by the vehicle's control unit, and is later being used for optimizing the clutch control in conjunction with the vehicle's control.

A hysteresis during the reverse movement, or the stick-slip effects of the mechanical parts of the clutch control, are causing a deviation between the predetermined pressure of the captured, actual curve in the actuator and the captured waypoint position of the displacement sensor. The deviation, in accordance with a further embodiment of this invention, is being captured automatically by the vehicle's control, and the curve is being automatically modified, by way of reducing the effects or by cancelling them completely.

For implementing the method of this invention, a further pressure sensor is being provided, in addition to the displacement sensor, measuring the fluid pressure, and its output being connected to the vehicle's control unit, and storing a curve, showing the fluid pressure over the actuator's waypoints, so that the fluid pressure over waypoint curve is being used as a redundant parameter in the vehicle's control unit.

Beside the described redundancy functionality, the invention's method and the invention's device, respectively, are having additional advantages. For instance, the signals of the pressure sensors are being used for checking the plausibility of the displacement sensors, and vice versa, meaning that a discrepancy between the signals is pointing towards a malfunction, of either the displacement sensor or the pressure sensor.

In addition, a continuous checking of the clutch's disengaging force pattern is becoming possible, whereby, for instance, a checking is being performed, to determine if this disengaging force curve is staying within predetermined limit values.

Finally, the method is allowing a conclusion, in the case of a waypoint discrepancy between the displacement sensor, on one side, and the pressure signals on the other side, that the flow rates of the actuators, which are controlling the clutch's valve, have changed unintentionally and/or leakages have occurred in the pressure fluid system, so that effects are being monitored.

### BRIEF DESCRIPTION OF THE DRAWING

The invention is being further explained in the embodiment's example. For that purpose, a drawing is being added. The single figure is showing a schematically a device for controlling an automated or automatic clutch.

### DETAILED DESCRIPTION OF THE PREFERRED EMBODIMENTS

A clutch 4, being assigned to the transmission 2, is being activated by a fluid pressure drive actuator 6. The drive actuator 6 comprises a cylinder enclosure 8 and in it, an axially positioned and sliding piston 10, which is functionally being linked, by a piston rod 12, with the clutch 4. It is being assumed that the clutch 4 is an actively opening clutch, whereby it is being engaged, by a spring not being shown, and being disengaged by the drive actuator 6.

The drive actuator 6 is being shown in the present embodiment as a hydraulic actuator, which is being controlled through a valve configuration 14. For disengaging the clutch 4, a pump 16 is providing by suctioning from a tank 18 a hydraulic fluid, through the valve configuration 14 and a pressure fluid line 20 into the head chamber 22 of the cylinder enclosure 8, so that the piston 10, as in the drawing, is sliding over to the right, disengaging the clutch 4 by overcoming the force of a clutch spring. For engaging the clutch, the pressure fluid line 20 is being connected, through the valve configuration 14, to the return line 24, so that the piston 10, under the force from the not shown clutch spring, is sliding to the left, and the hydraulic fluid, residing in the head chamber 22, is being moved, through the pressure fluid line 20, the valve configuration 14, and the return line 24, back into the tank 18.

The valve configuration 14 is being controlled by a vehicle control 26, which comprises the interaction with the related clutch control. The vehicle control system 26 is receiving, for its part, an input signal (automated clutch) through a clutch pedal, being operated by the driver, or, depending on input characteristics such as the engine's torque, selected gear, vehicle's speed, similar signals having been generated (automatic clutch).

The movement of the piston rod 12 is being captured by a displacement sensor 28, later being entered into the vehicle control system 26 with the clutch control, and being processed in it. In addition, the hydraulic fluid pressure inside the head chamber 22 is being captured by the pressure sensor 30, a derived signal also being entered into the vehicle control system 26, whereby it is being analyzed in the previously described manner.

In the vehicle control system 26, a nominal characteristic curve 32 is being deposited, which is indicating the nominal fluid pressure, as a function of the waypoint position of the piston rod 12. As long as an actually measured fluid pressure is matching the nominal fluid pressure, the system is working accordingly. The deviation of the actually measured fluid pressure from the nominal fluid pressure is an indication of an irregularity of the system, which is pointing out, for instance and as previously being described, possible leakages of the system or a necessity for a newly optimization of the clutch control.

As long as the pressure sensor 30 and also the displacement sensor 28 are working without interrupts, the plausibility of their measured values can be monitored in the vehicle control system 26. During a failure of the displacement sensor 28, the pressure sensor 30 is providing through a curve 32 a related to the waypoint information, derived from the measured pressure, so that at least an emergency drive function is being maintained.

### REFERENCE CHARACTERS

2 Transmission
4 Clutch
6 Drive Actuator
8 Cylinder Enclosure
10 Piston
12 Piston Rod, Actuator
14 Valve Configuration
16 Pump
18 Tank
20 Pressure Fluid Line
22 Head Chamber
24 Return Line
26 Vehicle Control System
28 Displacement Sensor
30 Pressure Sensor
32 Characteristic Curve
P Pressure
s Travel Range

1-7. (canceled)

8. A method of controlling an automatic or automated clutch (4) of a vehicle by a pressure fluid drive actuator (6) whereby a waypoint of a part (12), connected with the drive actuator (6), being captured by a displacement sensor (28) and entered into a clutch control, connected with the vehicle control system (26), and the method comprising the steps of:
creating a curve (32), relating to a pressure change in the drive actuator (6) as function of the waypoint change of the actuator (12), and
capturing a pressure (P) in drive actuator (6) by a pressure sensor (30), and using the captured pressure as an additional control parameter for the clutch control, whereby an actual pressure pattern in the drive actuator (6), during engagement and disengagement movement of the clutch (4), is stored and compared to a waypoint pattern of actuator (12), and
updating the curve (32) with the actual pressure values.

9. The method according to claim 8, further comprising the step of modifying the curve (32) so as to one of reduce and eliminate any hysteresis of the waypoint of the actuator (12), when one of reversing a motion and during a stick-slip-effect of mechanical parts of the clutch, captured in curve (32) as deviation of an actual pressure waypoint pattern.

10. The method according to claim 8, further comprising the steps of at least one of using signals of the pressure sensor (30), for checking a plausibility of the signals of the displacement sensor (28). and
using signals of the displacement sensor (28), for checking a plausibility of the signals of the pressure sensor (30).

11. The method according to claim 10, further comprising the step of a continuous checking the pattern of the disengagement force curve (32) of the clutch (4) to ensure that they remain within the limit values.

12. The method according to claim 8, further comprising the step of assuming, in case of a waypoint discrepancy between the signals of the displacement sensor (28), on one hand, and the signals of the pressure sensor (30), on the other hand, that an amount of flow through the clutch valves, controlling the drive actuator (6), is at least one of experiencing unwanted changes and leakage is occurring in the pressure fluid system.

13. A device for controlling an automatic or automated clutch of a vehicle being activated by a pressure fluid drive actuator, whereby the waypoint of a part (actuator), being connected with a drive actuator, being captured by a displacement sensor and being entered as a control parameter into a clutch control which is operating in conjunction with the vehicle control unit, wherein, in addition to the displacement sensor (28), a pressure sensor (30) is provided for measuring a fluid pressure of the drive sensor (6), and an output of the pressure sensor (30) is connected to the vehicle control system (26) and a curve (32) is stored in the vehicle control system, linking the fluid pressure with the waypoint of the actuator (piston rod 12), so that the fluid pressure, over the waypoint of the actuator, is used as redundancy control parameter in the vehicle control system (26).
